(19) United States
(12) Patent Application Publication
(10) Pub. No.: US 2024/0356323 A1
(43) Pub. Date: Oct. 24, 2024

(54) BURIED PIPE

(71) Applicant: NIPPON TELEGRAPH AND TELEPHONE CORPORATION, Tokyo (JP)

(72) Inventors: Daisaku NISHIYAMA, Tokyo (JP); Kenji HIYOSHI, Tokyo (JP); Akira ITO, Tokyo (JP); Koji ITASAKA, Tokyo (JP)

(73) Assignee: NIPPON TELEGRAPH AND TELEPHONE CORPORATION, Tokyo (JP)

(21) Appl. No.: 18/683,463

(22) PCT Filed: Aug. 16, 2021
(86) PCT No.: PCT/JP2021/029949

§ 371 Date: Feb. 13, 2024

(51) Int. Cl. H02G 9/06

(52) U.S. Cl. CPC H02G 9/06

(57) ABSTRACT

The buried pipe 1 (1a, 1b, 1c) includes a first inner pipe 12 capable of accommodating a cable 9, a second inner pipe 11 for accommodating the first inner pipe 12, and an outer pipe 10 for accommodating the second inner pipe 11, wherein the second inner pipe 11 is rotatable about a central axis L of the first inner pipe 12 with respect to the first inner pipe 12 and the outer pipe 10.

### TECHNICAL FIELD

The present disclosure relates to a buried pipe.

### BACKGROUND ART

It is known that a buried pipe for accommodating cables is used when various types of cables such as optical fibers and power transmission lines are buried in the ground. In a state in which the buried pipe is buried in the ground under a road or the like to form a buried pipe line, in a shallow layer section where sufficient soil covering cannot be ensured between the ground surface and the buried pipe, there is a high risk that the buried pipe line becomes damaged from an excavating machine and the like such as a backhoe, a breaker or a cutter due to road construction or the like.

In order to prevent damage to the buried pipe line in the shallow layer section, it is known to install, between the ground surface and the buried pipe, a sign sheet indicating that the buried pipe is buried, or an iron plate, a ceramic plate, a metal plate or the like for preventing intrusion of heavy machinery (PTL 1 to 3).

### CITATION LIST

### Patent Literature

[PTL 1] Japanese Patent Application Publication No. 2001-355758
[PTL 2] Japanese Patent Application Publication No. 2007-143355
[PTL 3] Japanese Patent Application Publication No. 2015-180166

### SUMMARY OF INVENTION

### Technical Problem

However, in the conventional configuration, although a reasonable space above the buried pipe is required, since it is difficult to secure the separation from the ground surface to the buried pipe depending on the structure of terrain, a stratum, or the like, in some cases the buried pipe line cannot be protected appropriately.

An object of the present disclosure is to provide a buried pipe configured to enable appropriate protection of a buried pipe line even when it is difficult to secure separation from the ground surface to a buried pipe.

### Solution to Problem

A buried pipe according to one embodiment includes: a first inner pipe capable of accommodating a cable; a second inner pipe accommodating the first inner pipe; and an outer pipe accommodating the second inner pipe, wherein the second inner pipe is rotatable about a central axis of the first inner pipe with respect to the first inner pipe and the outer pipe.

### Advantageous Effects of Invention

According to the present disclosure, even when it is difficult to secure separation from the ground surface to the buried pipe, the buried pipe line can be appropriately protected.

### BRIEF DESCRIPTION OF DRAWINGS

FIG. 1 is a cross-sectional view showing a configuration example of a buried pipe according to an embodiment.

FIG. 2 is a side view of the buried pipe shown in FIG. 1.

FIG. 3 is a cross-sectional view showing an example of the buried pipe shown in FIG. 1.

FIG. 4 is a diagram schematically showing a state in which the buried pipe of FIG. 1 protects a cable from a cutter.

FIG. 5 is a diagram schematically showing a state in which the buried pipe of FIG. 1 protects a cable from a breaker.

FIG. 6 is a cross-sectional view showing another configuration example of the buried pipe according to an embodiment.

### DESCRIPTION OF EMBODIMENTS

An embodiment of the present disclosure will be described hereinafter with reference to the drawings. In each of the drawings, parts with the same configuration or function are marked with the same reference numeral. In the description of the present embodiment, overlapping descriptions of identical parts may be appropriately omitted or simplified.

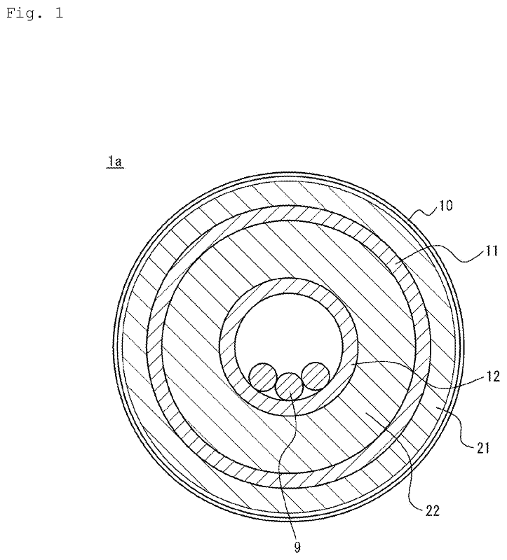

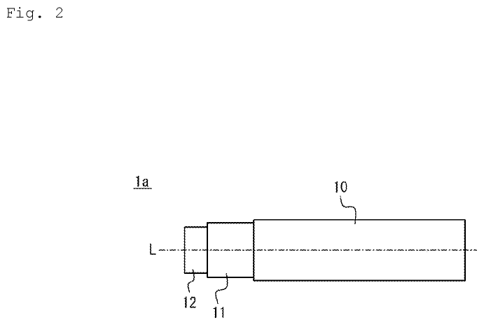

By having a configuration for protecting a buried pipe line inside a buried pipe 1 (1a, 1b, 1c), the present disclosure makes it possible to reduce a protective space more than a conventional configuration, and to protect the buried pipe line even when it is difficult to secure separation (depth) from a road surface. FIG. 1 is a cross-sectional view showing a configuration example of the buried pipe 1 (1a) according to an embodiment. FIG. 2 is a side view of the buried pipe 1a shown in FIG. 1. The buried pipe 1a protects various types of cables 9 such as an optical fiber and a power transmission line that are buried in the ground. The buried pipe 1a includes an outer pipe 10, inner pipes 11, 12, and rotating layers 21, 22.

The inner pipe 12 functioning as the first inner pipe is a tubular member capable of accommodating the cable 9. The inner pipe 11 functioning as the second inner pipe is a tubular member for accommodating the inner pipe 12. The inner pipes 11, 12 may be made of a hard material such as steel. The outer pipe 10 is a tubular member for accommodating the inner pipes 11, 12. The outer pipe 10 may be made of a material such as a vinyl chloride resin or a metal containing steel. The outer pipe 10 may be fixed in the ground by a member such as a joint. In the example shown in FIG. 1, the inner pipes 11, 12 and the outer pipe 10 each have a concentric circular cross section having a common central axis L (see FIG. 2). Since the inner pipe 12 for accommodating the cable 9 is accommodated in the inner pipe 11 and the outer pipe 10 as described above, a buried pipe line is protected from damage caused by intrusion of excavation machinery such as a backhoe, a breaker, or a cutter by a multilayered structure.

The inner pipe 11 is capable of rotating with respect to the outer pipe 10 about the central axis L of the inner pipes 11, 12 (as a rotation axis). Therefore, even if the edge of an excavating machine or the like enters the outer pipe 10, the inner pipe 11 rotates with respect to the outer pipe 10 to divert the edge, and thereby the edge can be prevented from cutting the inner pipe 11 and its inside, preventing the impact of the edge from being directly transmitted to the inside of the inner pipe 11. Since the buried pipe 1a has a configuration in which the inner pipe 11 can rotate with respect to the outer pipe 10, even if the edge of an excavating machine or the like enters the outer pipe 10, the buried pipe line and the cable 9 arranged in the buried pipe line can be protected.

Further, the inner pipe 11 can rotate with respect to the inner pipe 12 about the central axis L of the inner pipe 12 (as a rotation axis). Therefore, even if the edge of an excavating machine or the like enters the outer pipe 10 and the inner pipe 11 is rotated, the inner pipe 12 can be prevented from rotating along therewith. Therefore, even if the inner pipe 11 is rotated, the rotational force is absorbed between the inner pipes 11, 12, thereby preventing the cable 9 accommodated in the inner pipe 12 from being twisted and damaged by the rotation of the inner pipe 12.

The rotating layer 21 functioning as a second rotating layer is a layer that is provided between the inner pipe 11 and the outer pipe 10 and facilitates the rotation of the inner pipe 11 with respect to the outer pipe 10. The rotating layer 22 functioning as a first rotating layer is a layer that is provided between the inner pipe 12 and the inner pipe 11 and facilitates the rotation of the inner pipe 11 with respect to the inner pipe 12. The rotating layers 21, 22 are optional layers for reducing friction between the outer pipe 10 and the inner pipe 11 and between the inner pipes 11, 12. For example, the rotating layer 21 may be a slippery coating material such as fluorine, wax, or silicone applied to at least one of the surfaces of the outer pipe 10 and inner pipe 11. Similarly, the rotating layer 22 may be a slippery coating material such as fluorine, wax, or silicon applied to at least one of the surfaces of the inner pipes 11, 12. Alternatively, the rotating layers 21, 22 may be easily rotated by having a mechanical structure such as a ball bearing. Instead of providing the rotating layers 21, 22, the outer pipe 10 and the inner pipes 11, 12 may be made of a material having small friction when in contact with other members.

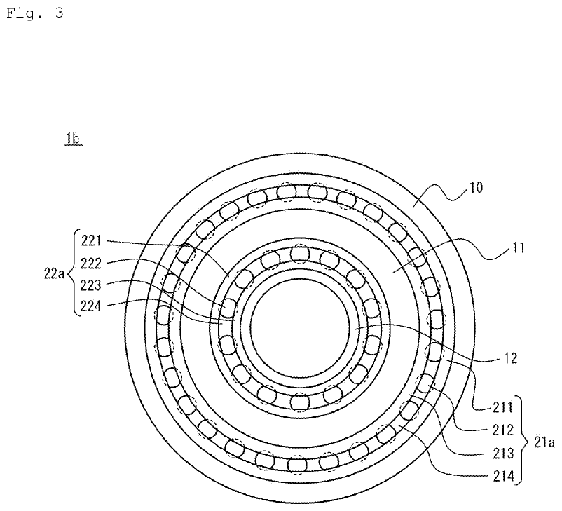

FIG. 3 is a cross-sectional view showing an example of the buried pipe 1 shown in FIG. 1. FIG. 3 shows an example of the buried pipe 1b in which rotating layers 21a, 22a are constituted by ball bearings. The rotating layer 21a of the buried pipe 1b is provided with an outer ring 211, a plurality of spheres 212, an inner ring 213, and a holding portion 214. The outer ring 211 is fixed to, for example, an inner surface of the outer pipe 10, and has a groove portion rotatable by contact with the sphere 212, on the inner surface side. The inner ring 213 is fixed to, for example, an outer surface of the inner pipe 11, and has a groove portion rotatable by contact with the spheres 212, on the outer surface side. The holding portion 214 holds a relative positional relationship of each sphere 212 so that the plurality of spheres 212 can rotate. When a relative rotational force with respect to the outer pipe 10 about the central axis L is applied to the inner pipe 11, the sphere 212 rotates between the outer ring 211 fixed to the inner surface of the outer pipe 10 and the inner ring 213 fixed to the outer surface of the inner pipe 11, and guides rotation of the inner pipe 11 with respect to the outer pipe 10. In this manner, in the buried pipe 1b, the plurality of spheres 212 whose relative positional relation is held by the holding portion 214 are rotated between the outer ring 211 and the inner ring 213, so that friction that occurs when the inner ring 213 rotates with respect to the outer ring 211 is reduced. Therefore, by providing the buried pipe 1b with the rotating layer 21a constituted of a ball bearing between the outer pipe 10 and the inner pipe 11, the inner pipe 11 can be easily rotated with respect to the outer pipe 10. Thus, the buried pipe 1b can effectively protect the buried pipe line and the cable 9 arranged in the buried pipe line.

The rotating layer 22a of the buried pipe 1b is provided with an outer ring 221, a sphere 222, an inner ring 223, and a holding portion 224. The outer ring 221 is fixed to, for example, an inner surface of the inner pipe 11, and has a groove portion rotatable by contact with the sphere 222, on the inner surface side. The inner ring 223 is fixed to, for example, an outer surface of the inner pipe 12, and has a groove portion rotatable by contact with the spheres 222, on the outer surface side. The holding portion 224 holds a relative positional relationship of each sphere 222 so that the plurality of spheres 222 can rotate. As with the rotating layer 21a, when a relative rotational force with respect to the inner pipe 12 about the central axis L is applied to the inner pipe 11, the friction that occurs when the outer ring 221 rotates with respect to the inner ring 223 by the rotation of the sphere 222 is reduced. Therefore, by providing the buried pipe 1b with the rotating layer 22a constituted of a ball bearing between the inner pipes 11, 12, the inner pipe 11 can be easily rotated with respect to the inner pipe 12. Therefore, even if the outer pipe 10 rotates, the buried pipe 1b can effectively prevent the cable 9 accommodated in the inner pipe 12 from being twisted and damaged, by absorbing the rotational force in the rotating layer 22a.

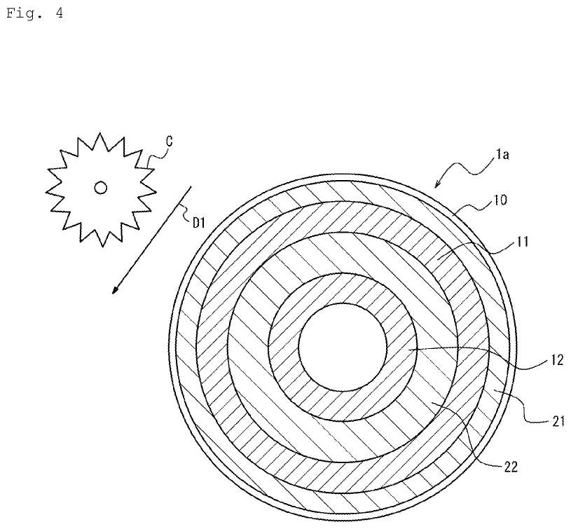

FIG. 4 is a diagram schematically showing a state in which the buried pipe 1a of FIG. 1 protects the cable 9 from a cutter C. In the example of FIG. 4, the cutter C rotating clockwise on the diagram is brought close to the buried pipe 1a, to apply a torque D1 to the outer pipe 10. Accordingly, the counterclockwise rotation of the inner pipe 11 with respect to the outer pipe 10 diverts the point of contact of the edge of the cutter C and prevents the edge from entering the inner pipe 11. Therefore, the buried pipe 1a can prevent the inside of the inner pipe 11 from being damaged. Since the buried pipe 1a has the inner pipe 12 inside the inner pipe 11, the inner pipe 12 accommodating the cable 9 and being capable of rotating about the central axis L with respect to the inner pipe 11, the rotation of the inner pipe 12 can be suppressed even if the inner pipe 11 rotates. Since the buried pipe 1a has a multiple structure of the mutually rotatable inner pipes 11, 12, the cable 9 is prevented from being twisted by the rotation of the inner pipe 12 accommodating the cable 9.

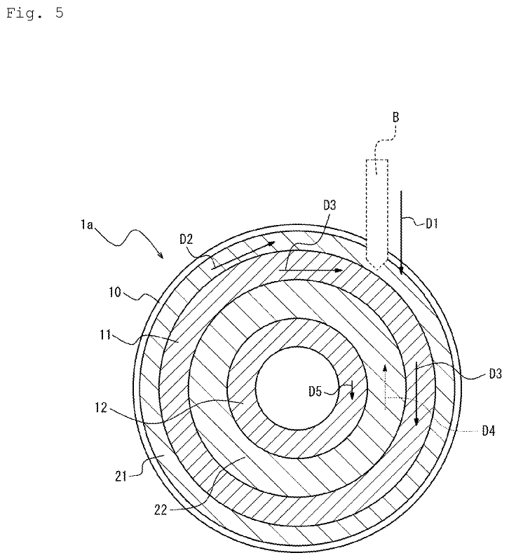

FIG. 5 is a diagram schematically showing a state in which the buried pipe 1 of FIG. 1 protects the cable 9 from a breaker B. In the example shown in FIG. 5, the edge of the breaker B breaks through the outer pipe 10 from the upper right upper portion of the buried pipe 1a in the diagram, and enters the inside of the rotating layer 21, to apply a rotating force D1 downward. Accordingly, a clockwise rotational force D2 is generated in the rotating layer 21, and a clockwise rotational force D3 is also generated in the inner pipe 11. Here, the rotating layer 22 for facilitating rotation of the inner pipe 11 with respect to the inner pipe 12 is provided between the inner pipes 11, 12, and the rotating layer 22 suppresses transmission of the rotational force D3 to the inner pipe 12. In FIG. 5, the action of the rotating layer 22 is schematically shown as a force D4 for canceling the rotational force D3. As a result of the suppression by the rotating layer 22, a rotational force D5 applied to the inner pipe 12 becomes extremely small even if it exists. Therefore, according to the buried pipe 1a, the cable 9 can be prevented from being twisted. Further, by providing a plurality of the inner pipes 11, 12 in the outer pipe 10, the edge of an excavating machine or the like must pass through a large number of outer pipes 10 and inner pipes 11, 12 in order to reach the buried pipe line. Therefore, the buried pipe line and the cable 9 arranged in the buried pipe line can be more effectively protected.

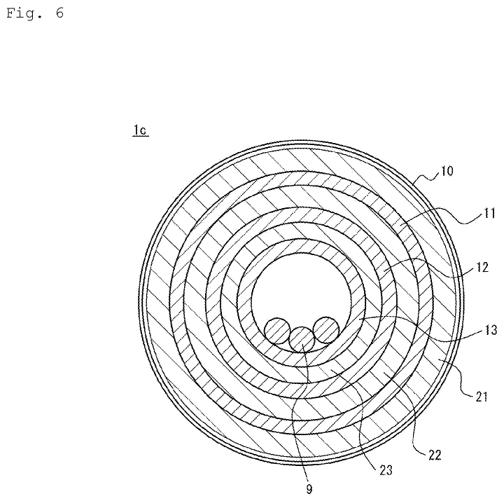

The buried pipes 1a, 1b are provided with two mutually rotatable inner pipes 11, 12 inside the outer pipe 10, but the buried pipe 1 may have a multilayered structure of three or more mutually rotatable inner pipes. FIG. 6 is a cross-sectional view showing a configuration example of the buried pipe 1c provided with three mutually rotatable inner pipes 11 to 13. The buried pipe 1c further includes an inner pipe 13 and a rotating layer 23 in addition to the configuration of the buried pipe 1a. The inner pipe 13 may be made of a hard material such as steel, as with the inner pipes 11 and 12. The inner pipe 13 is capable of accommodating the cables 9. The rotating layer 23 is provided between the inner pipes 12, 13, and facilitates rotation of the inner pipe 12 with respect to the inner pipe 13. As with the rotating layers 21, 22, the rotating layer 23 may be a slippery coating material applied to at least one of the surfaces of the inner pipes 12, 13, or a ball bearing. Instead of providing the rotating layer 23, the inner pipes 12, 13 may be formed of a material having small friction when in contact with other members.

When the buried pipe 1c has a multilayered structure of three or more mutually rotatable inner pipes 11 to 13 as shown in FIG. 6, even if the inner pipe 11 rotates, the rotational force transmitted to the inner pipe 13 for accommodating the cable 9 can be further reduced. By providing the rotating layers 21 to 23, the rotating force is absorbed, and the cable 9 accommodated in the inner pipe 13 is more effectively prevented from being twisted and damaged. In addition, since the edge of an excavating machine or the like must pass through the outer pipe 10 and a large number of inner pipes 11 to 13 to reach the buried pipe line, the buried pipe line and the cable 9 arranged in the buried pipe line can be protected more effectively.

Since the buried pipe 1 (1a, 1b, 1c) according to the present disclosure is configured to protect a buried pipe line, it is possible to reduce a protective space more than a conventional configuration and protect the buried pipe line even when it is difficult to secure separation (depth) from the road surface.

The present disclosure is not limited to the embodiment described above, and modifications can be made without departing from the scope of the present disclosure.

### REFERENCE SIGNS LIST

1a, 1b, 1c Buried pipe
9 Cable
10 Outer pipe
11 to 13 Inner pipe
21 to 23 Rotating layer
211, 221 Outer ring
212, 222 Sphere
213, 223 Inner ring
214, 224 Holding portion
L Central axis
B Breaker
C Cutter

1. A buried pipe, comprising:
a first inner pipe comprises a cable in an interior of the first inner pipe;
a second inner pipe comprises the first inner pipe; and
an outer pipe comprises the second inner pipe,
wherein the second inner pipe is rotatable about a central axis of the first inner pipe with respect to the first inner pipe and the outer pipe.

2. The buried pipe according to claim 1, further comprising a first rotating layer between the first inner pipe and the second inner pipe, the first rotating layer enabling the second inner pipe to rotate with respect to the first inner pipe.

3. The buried pipe according to claim 2, wherein the first rotating layer comprises a coating material.

4. The buried pipe according to claim 1, further comprising a second rotating layer between the second inner pipe and the outer pipe, the second inner pipe rotating with respect to the outer pipe according to the second rotating layer.

5. The buried pipe according to claim 4, wherein the second rotating layer comprises a coating material.

6. The buried pipe according to claim 2, wherein the first rotating layer comprises a bearing.

7. The buried pipe according to claim 2, further comprising a second rotating layer between the second inner pipe and the outer pipe, the second inner pipe rotating with respect to the outer pip according to the second rotating layer.

8. The buried pipe according to claim 3, further comprising a second rotating layer between the second inner pipe and the outer pipe, the second inner pipe rotating with respect to the outer pip according to the second rotating layer.

9. The buried pipe according to claim 4, wherein the second rotating layer comprises a bearing.

10. The buried pipe according to claim 1, wherein the outer pipe rotates in response to an edge of an excavating machine to divert the edge, and the second inner pipe is without rotating.
